(19) United States
(12) Patent Application Publication
(10) Pub. No.: US 2016/0130784 A1
(43) Pub. Date: May 12, 2016

(54) CONTROL SYSTEM FOR EARTH MOVING EQUIPMENT

(71) Applicant: Dennis DUELLO, Vinton, IA (US)

(72) Inventor: Dennis DUELLO, Vinton, IA (US)

(21) Appl. No.: 14/934,775

(22) Filed: Nov. 6, 2015

Related U.S. Application Data
(60) Provisional application No. 62/076,589, filed on Nov. 7, 2014.

(51) Int. Cl. E02F 9/20; G05G 9/00; G05G 1/04; B60R 16/023

(52) U.S. Cl. CPC E02F 9/2004; B60R 16/023; G05G 9/00; G05G 1/04

(57) ABSTRACT

A control system for controlling different aspects of an earth moving vehicle such as a caterpillar is disclosed. The system utilizes movement of the forearm, wrist, fingers and thumb to control at least five functions. Multiple pivot points allow the control system to move different parts in two different directions each and can be used independently of one another. The control system can also be utilized in controlling a variety of devices other than earthmoving vehicles.

### CROSS-REFERENCE TO RELATED APPLICATIONS

The present application claims priority to provisional patent application 62/076,589 which was filed on Nov. 7, 2014, and is hereby expressly incorporated by reference in its entirety.

### BACKGROUND OF THE INVENTION

The present invention relates generally to tools and equipment used in the construction industry. Since their introduction into industry, construction and agriculture in the 20th century, hydraulically operated machines have been developed and expanded to include a wide range and variety of functions. Since late in the 20th century, electro-hydraulics (or electric-over-hydraulics) have been added to hydraulics. Since the electric switches and wires used in electro-hydraulics are much smaller than the hydraulic valves and hoses they were developed to control, necessary hydraulic components can be located remotely from the operator's station. In addition, numerous small electro-hydraulic control switches can be located in a much smaller space than the hydraulic components allowing “finger-tip” controls in some applications.

This invention makes great use of this benefit in locating such small switches and easily routed wires in a manner allowing for the use of intuitive movements of the human body to control hydraulic or otherwise powered machine operations, providing greatly increased coordination, comfort, efficiency, safety, and production, as well as a substantially reduced learning curve. The invention provides operators the ability to control a plurality of parts of a vehicle while only utilizing one arm/hand. Not only does this free up use of the other arm/hand, it frees up the legs of the operator. Furthermore, the requirement of one arm/hand can allow those with physical limitations the ability to operate the vehicle.

The invention is a systematic ergonomics improvement over the current state of the art. The invention allows for improved human performance and productivity and at the same time decreases any high force requirements to move parts of the vehicle. The positioning of the controls does not lend itself to awkward postures and maintains the user in a comfortable posture, thus reducing physical injuries due to physical exertions of operating the vehicle.

It is therefore an object of the invention to provide an intuitive arrangement for controls that is an ergonomic improvement.

It is a further object of the invention to provide a control system which has a variety of controls which are manipulated by the forearm, hands, and wrists of the user in a coordinated and ergonomic manner unseen to date.

### SUMMARY OF THE INVENTION

The control system of the invention utilizes a variety of control functions operated by the user's arm, wrist, palm, fingers and thumb. The system provides for the intuitive and ergonomic operation of control input devices in strategic locations. Although the control system can be customized for a variety of applications, the following is a description based upon a typical hydraulic excavator.

An excavator comprises first a boom, a structural member pivoted at the low front of the operator's cabin and having an operating range generally between straight up, through far forward, then nearly straight downward. Pivotally attached to the boom is a structural member commonly known as a stick, an articulated extension of the boom, with a range of motion generally between a position of being nearly in line with the boom and a position of being rotated/folded downward and inward nearly parallel to the boom. At the end of the boom, a number of devices can be attached. These devices include rotating buckets, claws, grapples, compactors, and hammers. In addition, an end device commonly called a thumb can be attached opposite to and facing the bucket for use in grasping materials or forcing them into the bucket. Most commonly the thumb is pivotally attached and hydraulically operated. The current invention allows a two-way control input for five different control functions.

### BRIEF DESCRIPTION OF THE DRAWING

FIG. 1 is a perspective view of a control system for heavy equipment vehicles mounted on or next to an operator's chair;

FIG. 2 is a side view of the control system;

FIG. 3 is a front view of the control system;

FIG. 4 is a perspective view of the control system;

FIG. 5 is a perspective view of the control system from a generally bottom view;

FIG. 6 is a perspective view of the control system from a generally right side view;

FIG. 7 is a perspective view of the control system from a generally top and front view;

FIG. 8 is a top view of the control system showing the control system in three different positions.

### DESCRIPTION OF THE PREFERRED EMBODIMENT OF THE INVENTION

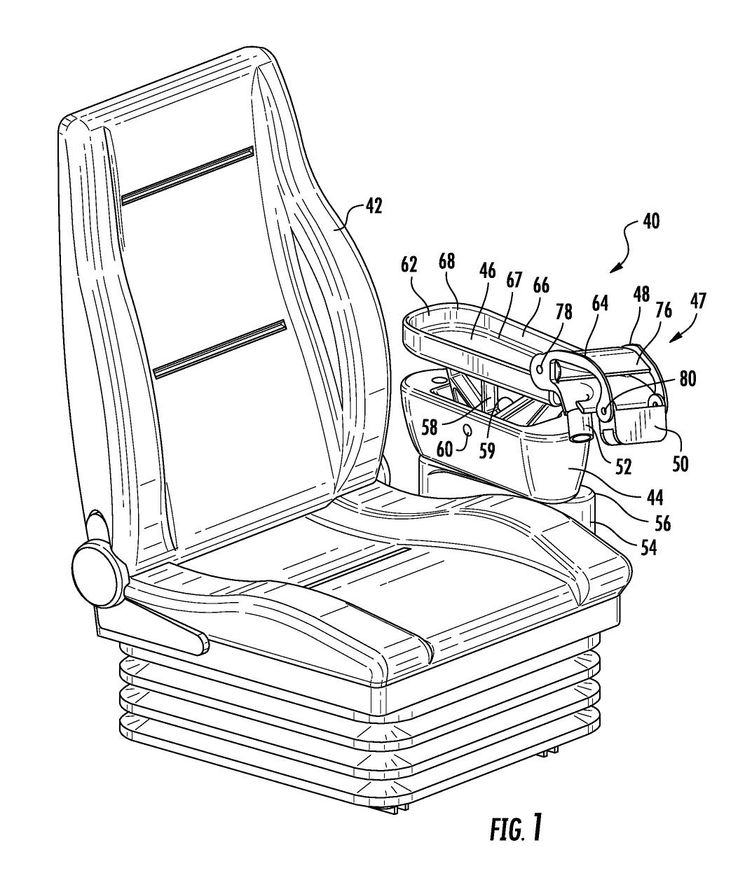

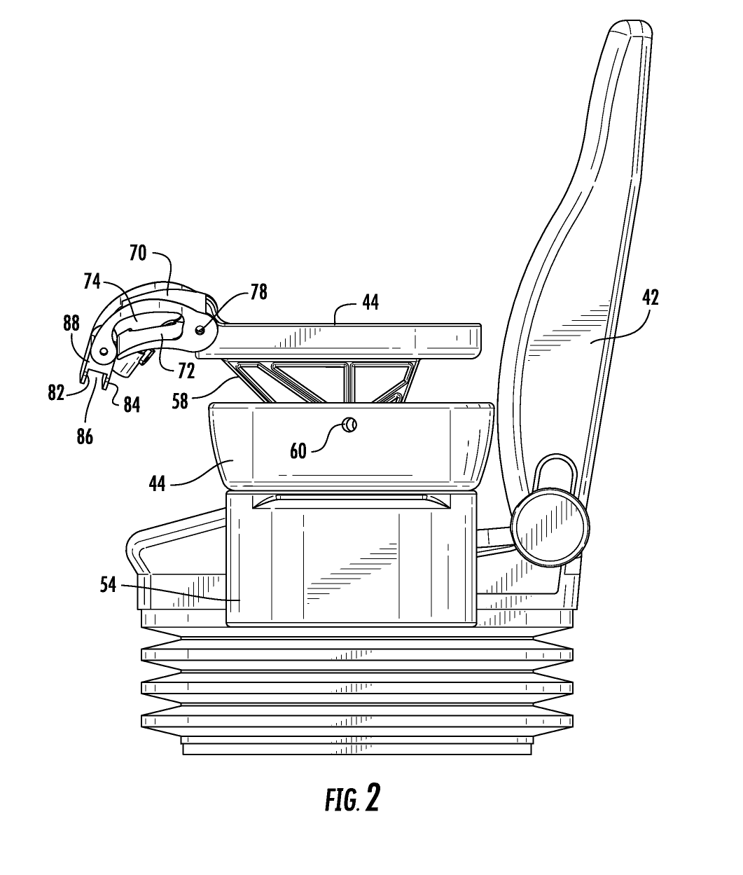

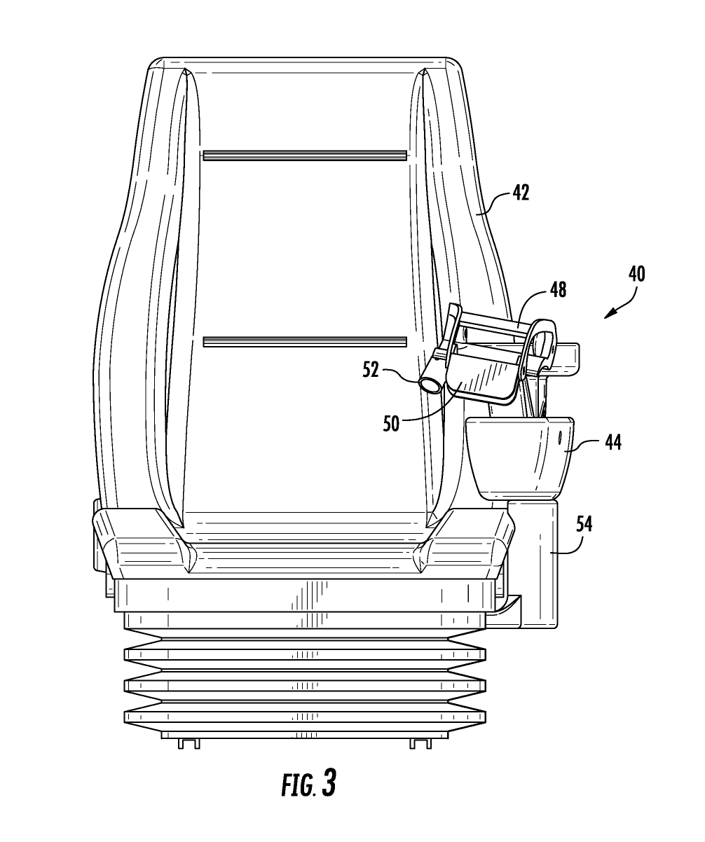

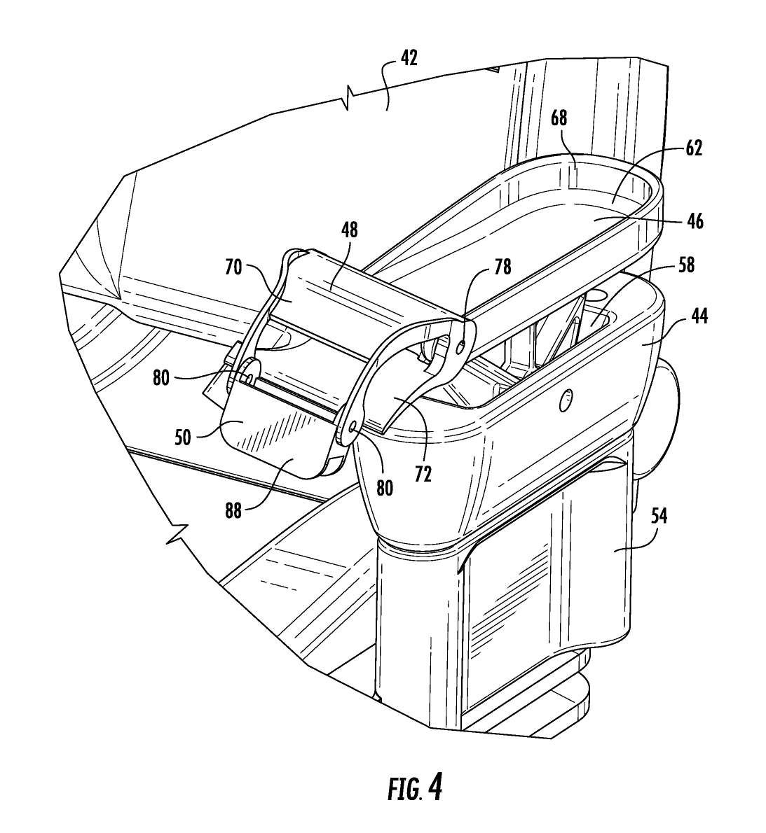

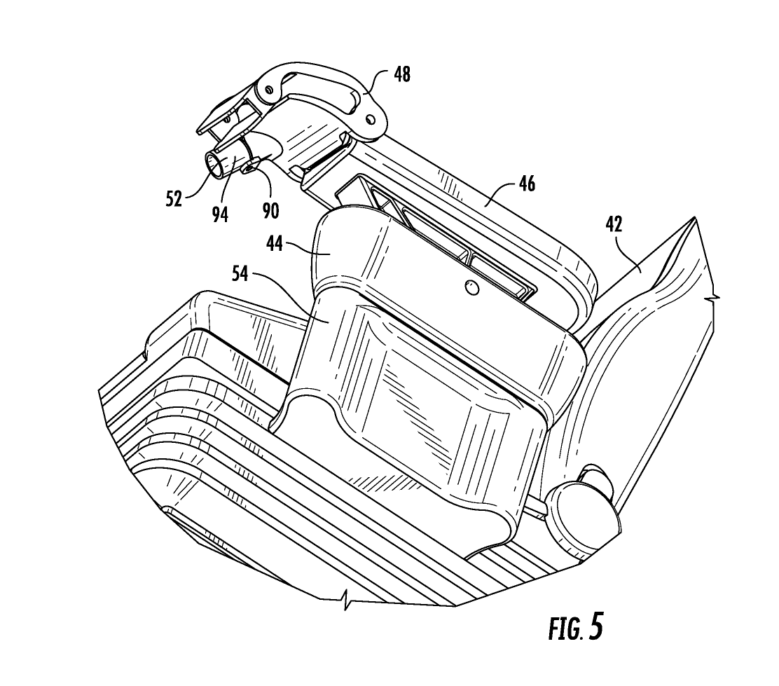

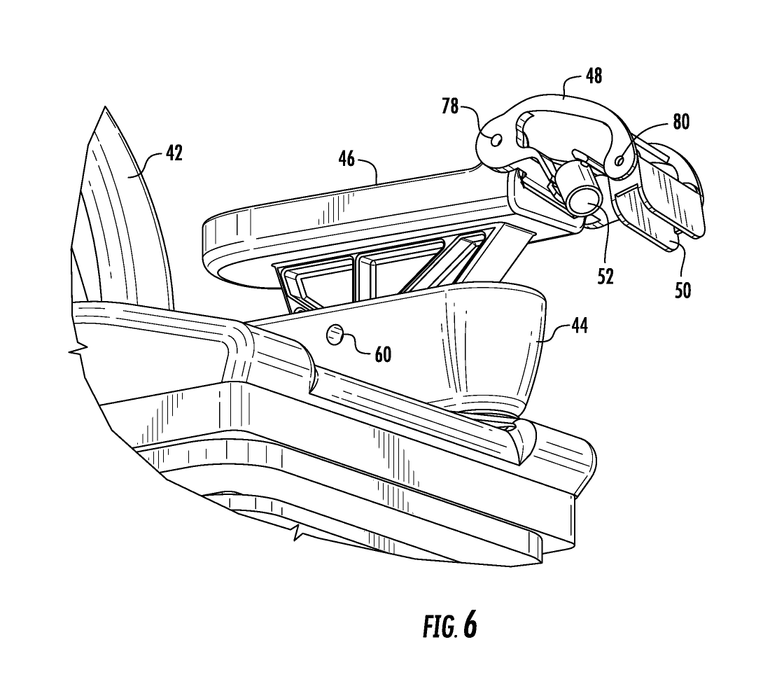

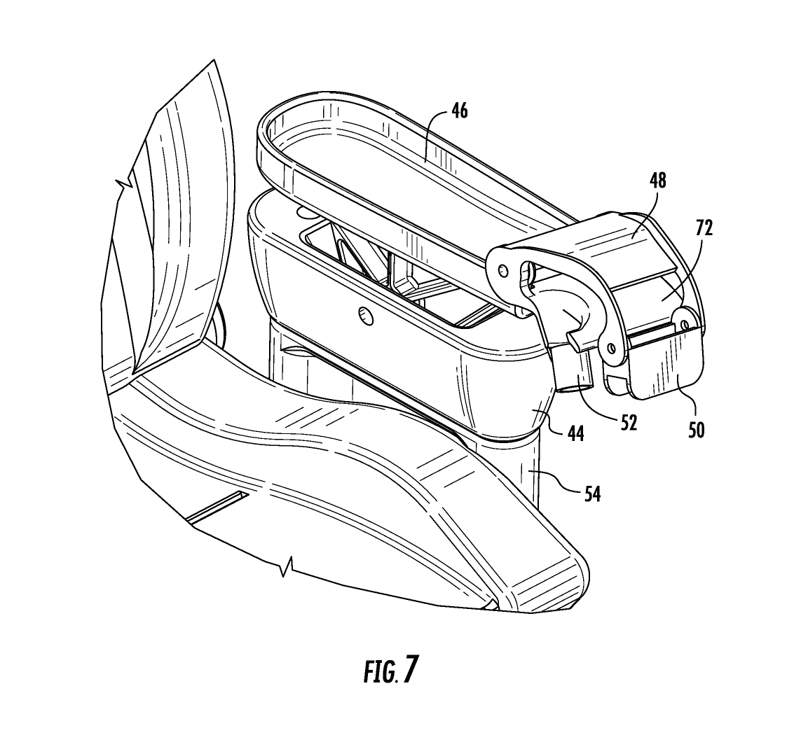

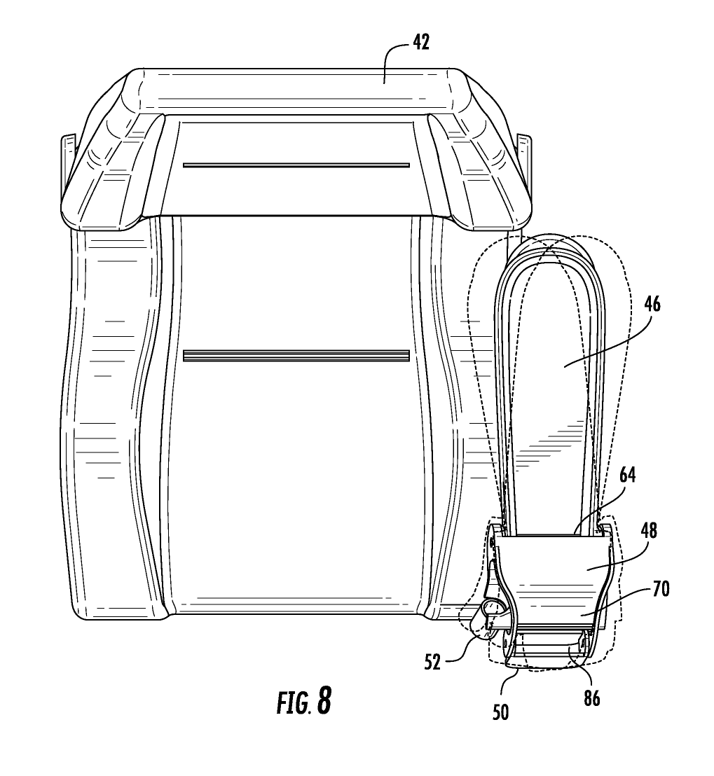

Referring to FIGS. 1-8, a control system 40 is positioned to the left of a chair 42, although the control system 40 can be positioned to the right of the chair 42 if desired. Accordingly, in the embodiment shown in the FIGS. 1-8, a user of the invention would use his or her left arm and hand in manipulating the control system 40. The main components of the control system 40 are a base unit 44, a forearm rest member 46, a hand member 48, a finger member 50, and a thumb member 52. The hand member 48, the finger member 50 and the thumb member 52 are part of an overall handle 47. While any one or more of the main components could be removed to form a different embodiment, the preferred embodiment includes all of the main components.

The base unit 44 can sit upon a platform 54. The base unit is pivotally attached to the platform 54 such that the base unit can pivot left to right in a horizontal plane. Movement of the base unit 44 is a first control 56 of the control system 40. The base unit 44 comprises a cavity 57 which at least partially houses a linkage 58.

The linkage 58 preferably comprises a plurality of radial members 59. The linkage members 59 extend from the base unit 44 and connect to the forearm rest member 46. At least one of the radial members 59 are pivotally attached to the base unit 44. Preferably the pivot point is at a first point 60. The forearm rest member 46 is pivotable as it is attached to the linkage. The forearm rest member 46 is movable in the vertical plane, up and down, depending on how the user puts force on a first end 62 and/or second end 64 of the forearm rest member 46. Movement of the forearm rest member 46 is a second control 66 of the control system 40.

The forearm rest member 46 has a bottom 67 which is substantially planar for a typical human forearm to rest upon. The forearm rest member 46 preferably has a lip 68 which assists in maintaining the position of the user's arm on the forearm rest member 46.

At the second end 64 of the forearm rest member 46, the handle 47 is pivotally attached at pivot points 78. The handle 47 comprises the hand member 48 which has an upper portion 70 and a lower portion 72. A space 74 between the upper portion 70 and lower portion 74 serves as a location for a user's hand. The user's hand rests on the lower portion 72. The hand member 50 is movable in the vertical plane, up and down, when the user bends his or her wrist. In order to move the hand member 48 upward, the user pushes on the upper portion 70. Movement of the hand member 48 is a third control 76 of the control system 40.

The finger member 50 is pivotally attached to the hand member 48 at points 80. The finger member has an upper portion 82 and a lower portion 84. Similar to the hand member 50, a space 86 between the upper portion 82 and the lower portion 84 allows a user to insert at least one finger into the space 86. The finger member 50 is movable in the vertical plane, up and down, when the user bends the fingers that are in the space 86. In order to move the finger member 50 upward, the user pushes on the upper portion 82, to move downward, the user pushes on the lower portion 84. Movement of the finger member 50 is a fourth control 88 of the control system 40.

The thumb member 52 is pivotally attached to a portion of the hand member 48, preferably the lower portion 72 at points 90. The thumb member 52 is preferably cylindrical forming a space 92 for insertion of the user's thumb. The thumb member 52 is movable preferably in a vertical plane, up and down, when the user bends the thumb. Movement of the thumb member 52 is a fifth control 94 of the control system 40.

It is to be understood that the pivot points described above could be modified and/or relocated such that movement of any one of the controls could me moved in a different plane. For instance, the hand member could be pivotally attached to the forearm rest member differently such that the user would need to utilize horizontal movement of the wrist to move the hand member.

When in use, a user will place his forearm on the forearm rest member 46 such that the user's elbow is at or near the first end 62. The user then slides his or her hand through space 74 between upper portion 70 and lower portion 72 of the hand member 48 whereby the user's bottom portion of his hand rests on the lower portion 72. At least one of the user's fingers then at least partially pass through space 86 between upper portion 82 and lower portion 84 of the finger member 50. The user then slides his thumb through the space 92 of the thumb member 52.

The first control 56 can manipulate a first part of a vehicle such as a chassis of an excavator by the movement of the forearm in a counter-clockwise or clockwise motion. As the base unit 44 is pivotally attached to the platform 54, the user or operator of the control unit 40 can move the base unit 44 from left to right to control the first part of the vehicle. In the preferred embodiment, the first part is the chassis of the vehicle, such as the chassis of an excavator. A user can move his forearm to the left which causes the base unit 44 to pivot in a counterclockwise direction. The movement to the left forces the chassis to move in a first direction. By moving his forearm to the right, the chassis is moved in a second direction, which would be a clockwise direction.

The second control 66 can manipulate the second part of the vehicle such as a boom of an excavator by the movement of the forearm in an upward or downward direction. Basically, when the user puts greater pressure at the second end 64 of the forearm rest member 46 relative to the first end 62 of the forearm rest member 46, the second end 64 moves downward toward the base unit 44. As the second 64 end moves down, the first end 62 moves up as the entire forearm rest member 46 via linkage 58 pivots around point 59. The pivoting moves the boom in a first direction. The boom can be moved in a second direction when the user puts greater pressure at the first end 62 which causes the first end 62 to move downward and the second end 64 to move upward.

The third control 76 can manipulate the third part of the vehicle such as a stick of an excavator by the movement of the user's wrist in an upward or downward direction. The hand member 48 pivots around points 78. As the user raises his hand by pivoting his wrist upward, the top side of the user's hand makes contact with upper portion 70 and force the hand member 48 upward. The upward manipulates the stick in a first direction. By pivoting his wrist downward, the stick can be moved in a second direction.

The fourth control 88 can manipulate the fourth part of the vehicle such as a bucket of an excavator by the movement of the user's finger(s) in an upward or downward direction. By pivoting the user's fingers upward, the fingers make contact with the upper portion 82 of the finger member 50 and force the finger member 50 upwards as the finger member 50 pivots around point 80. The upward movement of the finger member 50 moves the bucket in a first direction. Downward movement of the finger base 50 moves the bucket in a second direction.

The fifth control 94 can manipulate the fifth part of the vehicle such as the thumb of an excavator by the movement of the user's thumb, preferably in an upward or downward direction. The user's thumb is held at least partially within the thumb member 52. The thumb member 52 is pivotally attached to the hand member 48 at points 90. By manipulating the user's thumb upward, the thumb member 52 moves upward and moves the thumb of the excavator in a first direction. By manipulating the user's thumb downward, the thumb member 52 moves downward and moves the thumb of the excavator in a second direction. It is intended that the user's thumb and index finger meet or nearly meet during the operation to make the bucket and hydraulic thumb of the excavator move.

It is to be understood that the movement of the parts and controls of the invention described above are translated via electronic controls known in the art to move the specific parts of the equipment. For example, movement of the forearm rest member activates particular electronic controls that then move a particular part of the equipment or vehicle in which the control system is located.

Having thus described the invention in connection with the preferred embodiments thereof, it will be evident to those skilled in the art that various revisions can be made to the preferred embodiments described herein without departing from the spirit and scope of the invention. It is my intention, however, that all such revisions will be included within the scope of the following claims.

What is claimed is as follows:

1. A control system for a vehicle, comprising:
a first control wherein a user of the system manipulates the first control in a first direction to move a first part of the vehicle;
whereby the first control is manipulated by movement of a forearm of the user;
a second control wherein the user of the system manipulates the second control in a first direction to move a second part of the vehicle;
whereby the second control is manipulated by a wrist of the user;
a third control wherein the user of the system manipulates the third control in a first direction to move a third part of the vehicle;
whereby the third control is manipulated by fingers of the user;
a fourth control wherein the user of the system manipulates the fourth control in a first direction to move a fourth part of the vehicle;
whereby the fourth control is manipulated by the pressure generated by the user's elbow;
a fifth control wherein the user of the system manipulates the fifth control in a first direction to move a fifth part of the vehicle;
whereby the fifth control is manipulated by a thumb of the user.

2. The control system of claim 1, wherein:
the movement of the first control is manipulated by a horizontal movement of the forearm of the user.

3. The control system of claim 1, wherein:
the movement of the second control is manipulated by a vertical movement of the wrist of the user.

4. The control system of claim 1, wherein:
the movement of the third control is manipulated by a vertical movement of at least one finger of the user.

5. The control system of claim 1, wherein:
the movement of the fourth control is manipulated by a vertical movement of the entire lower arm of the user.

6. The control system of claim 1, further comprising:
a base unit;
a forearm rest member;
the base unit connected to the forearm rest member by a linkage;
the base unit pivotable in a substantially horizontal plane.

7. The control system of claim 6, wherein:
the forearm rest member pivotable in a vertical plane.

8. The control system of claim 7, further comprising:
a hand member pivotally connected to the forearm rest member;
the hand member pivotable in the vertical plane.

9. The control system of claim 8, wherein:
the hand member comprises a finger member whereby a user can insert his fingers;
the finger member pivotable in the vertical plane.

10. The control system of claim 9, wherein:
the hand member comprises a thumb member;
the thumb member pivotable in the vertical plane.

11. The control system of claim 10, wherein:
the finger member, the thumb member and the hand member are independently pivotable.

12. A control system for a vehicle, comprising:
a base unit;
the base unit movable;
a forearm rest member;
the base unit connected to the forearm rest member by a linkage;
the base unit pivotable in a substantially horizontal plane;
the forearm rest member pivotable in a vertical plane;
a hand member pivotally connected to the forearm rest member;
the hand member movable;
the hand member pivotable in the vertical plane.

13. The control system of claim 12, wherein:
the movement of the base unit controls a first part of the vehicle;
the movement of the forearm rest member controls a second part of the vehicle;
the movement of the hand member controls a third part of the vehicle.

14. The control system of claim 13, further comprising:
a finger member pivotally attached to the hand member;
the finger member movable;
the finger member pivotable in the vertical plane;
the movement of the finger member controls a fourth part of the vehicle.

15. The control system of claim 14, further comprising:
a thumb member pivotally attached to the hand member;
the thumb member movable;
the thumb member movable in the vertical plane;
the movement of the thumb member controls a fifth part of the vehicle.

16. The control system of claim 15, wherein:
the hand member comprises an upper portion and a lower portion wherein a hand of a user can be placed during operation;
a space is present between the upper portion and the lower portion.

17. The control system of claim 16, wherein:
the finger member has an upper and lower portion wherein at least one finger of the user can be placed during operation;
a second space is present between the upper portion and the lower portion.

18. The control system of claim 17, wherein:
the linkage comprises a plurality of radial members.

19. The control system of claim 18, wherein:
the base unit comprises a cavity;
the radial members partially housed within the cavity;
the radial members movable within the cavity.

20. A control system for a vehicle, comprising:
a base unit;
the base unit movable;
a forearm rest member;
the base unit connected to the forearm rest member by a linkage;
the base unit pivotable in a substantially horizontal plane;
the forearm rest member pivotable in a vertical plane;
a hand member pivotally connected to the forearm rest member;
the hand member movable;
the hand member pivotable in the vertical plane;
the movement of the base unit controls a first part of the vehicle;
the movement of the forearm rest member controls a second part of the vehicle;
the movement of the hand member controls a third part of the vehicle;
a finger member pivotally attached to the hand member;
the finger member movable;
the finger member pivotable in the vertical plane;
the movement of the finger member controls a fourth part of the vehicle;
a thumb member pivotally attached to the hand member;
the thumb member movable;
the thumb member movable in the vertical plane;
the movement of the thumb member controls a fifth part of the vehicle;
the hand member comprises an upper portion and a lower portion wherein a hand of a user can be placed during operation;
a space is present between the upper portion and the lower portion;
the linkage comprises a plurality of radial members;
the base unit comprises a cavity;
the radial members partially housed within the cavity;
the radial members movable within the cavity
a first control wherein a user of the system manipulates the first control in a first direction to move the first part of the vehicle;
a second control wherein the user of the system manipulates the second control in a first direction to move the second part of the vehicle;
a third control wherein the user of the system manipulates the third control in a first direction to move the third part of the vehicle;
a fourth control wherein the user of the system manipulates the fourth control in a first direction to move the fourth part of the vehicle;
a fifth control wherein the user of the system manipulates the fifth control in a first direction to move the fifth part of the vehicle;
the forearm rest member comprises a lip wherein the lip assists in maintaining the user's forearm in place.
